(19) United States
(12) Patent Application Publication
(10) Pub. No.: US 2016/0253591 A1
(43) Pub. Date: Sep. 1, 2016

(54) METHOD AND APPARATUS FOR MANAGING PERFORMANCE OF DATABASE

(71) Applicant: SAMSUNG SDS CO., LTD., Seoul (KR)

(72) Inventors: Sang-Hoon PARK, Seoul (KR); Jin-Wook KIM, Seoul (KR); Beom-Seog LEE, Seoul (KR)

(73) Assignee: SAMSUNG SDS CO., LTD., Seoul (KR)

(21) Appl. No.: 15/054,350

(22) Filed: Feb. 26, 2016

(30) Foreign Application Priority Data
Feb. 27, 2015 (KR) 10-2015-0028255

(51) Int. Cl. G06N 5/04; G06F 17/30

(52) U.S. Cl. CPC G06N 5/04; G06F 17/30289

(57) ABSTRACT

Methods for managing performance of a database. A method includes selecting an object table predicted to be required to perform a table reorganization (Reorg) after the current timing, using performance-related information of database collected for a predetermined time period or more, generating a predictive model for predicting the timing at which there is a need to perform the reorganization (Reorg) of the object table, and predicting the timing at which there is a need to perform the reorganization of the object table, using the predictive mode.

This application claims priority from Korean Patent Application No. 10-2015-0028255 filed on Feb. 27, 2015 in the Korean Intellectual Property Office, the disclosure of which is incorporated herein by reference in its entirety.

### BACKGROUND OF THE INVENTION

1. Field of the Invention

The present invention relates to a method and an apparatus for managing performance of database. More particularly, the present invention relates to a method and an apparatus for managing performance of database by predicting performance of database.

2. Description of the Related Art

As an amount of data to be stored and processed becomes enormous, companies and users utilizing the database have increased.

As existing techniques for managing performance of database, there has been a technique for supporting the function capable of quickly coping with an obstacle occurring in the database or a technique for merely monitoring the state of performance of database in real time.

### SUMMARY OF THE INVENTION

An aspect of the present invention provides a method and an apparatus for managing performance of database capable of previously preparing for risk elements of performance and obstacle having a high possibility of occurrence in the future.

Further, another aspect of the present invention provides a method and an apparatus for managing performance of database that generate a predictive model so that it is possible to improve a prediction accuracy of risk elements of performance and obstacle having a high possibility of occurrence in the future.

According to the present invention as described above, there is an effect capable of previously preparing for risk elements of performance and obstacle having a high possibility of occurrence in the future.

Specifically, for example, the present invention has an effect capable of previously predicting and preparing for timing which requires a table reorganization (Reorg), a disc relocation and/or an adjustment of the memory size, using performance-related information of the database.

Further, according to the present invention, it is possible to more accurately predict the timing that requires the table reorganization (Reorg), the disc relocation and/or the memory size adjustment, by generating or changing the predictive model when predicting the timing, rather than using a fixed predictive model.

Further, when using the present invention, it is possible to block the risk elements of the performance delay of the database in advance, and it is also possible to perform a task for preventing a performance delay, while having a reserve and a plan.

In some embodiments, a method for managing performance of database, the method comprising: selecting an object table predicted to be required to perform a table reorganization (Reorg) after the current timing, using performance-related information of database collected for a predetermined time period or more; generating a predictive model for predicting the timing at which there is a need to perform the reorganization (Reorg) of the object table, and predicting the timing at which there is a need to perform the reorganization of the object table, using the predictive model.

In some embodiments, a method for managing performance of database, the method comprising: selecting an object table predicted to be required to perform a disc relocation after the current timing, using performance-related information of database collected for a predetermined time period or more; predicting timing at which there is a need to perform the reorganization of the object table, using a predictive model to predict the timing at which there is a need to perform the reorganization (Reorg) of the object table, and providing the information on the predicted timing to a user.

In some embodiments, an apparatus for managing performance of database: a managed object selection unit that selects an object table predicted to be required to perform a table reorganization (Reorg) after the current timing, using performance-related information of database collected for a predetermined time period or more; a predictive model generation unit that generates a predictive model for predicting the timing at which there is a need to perform the reorganization of the object table, and a timing prediction unit that predicts the timing at which there is a need to perform the reorganization of the object table, using the predictive model.

In some embodiments, a method for managing performance of database, the method comprising: selecting an object table space predicted to be required to perform a disc relocation after the current timing, using performance-related information of database collected for a predetermined time period or more; generating a predictive model for predicting the timing at which there is a need to perform the disc relocation of the object table space, and predicting the timing at which there is a need to perform the disc relocation of the object table space, using the predictive model.

In some embodiments, a method for managing performance of database, the method comprising: selecting an object table space predicted to be required to perform a disc relocation after the current timing, using performance-related information of database collected for a predetermined time period or more; predicting timing at which there is a need to perform the disc relocation of the object table space, using a predictive model for predicting the timing at which there is a need to perform the disc relocation of the object table space, and providing the information on the predicted timing to a user.

In some embodiments, an apparatus for managing performance of database comprising: a managed object selection unit that selects an object table space predicted to be required to perform a disc relocation after the current timing, using performance-related information of database collected for a predetermined time period or more; a predictive model generation unit that generates a predictive model for predicting the timing at which there is a need to perform the disc relocation of the object table space, and a timing prediction unit that predicts the timing at which there is a need to perform the disc relocation of the object table space, using the predictive model.

In some embodiments, a method for managing performance of database, the method comprising: selecting an object memory area predicted to be required to adjust a memory size after the current timing, using performance-related information of database collected for a predetermined time period or more; generating a predictive model for predicting the timing at which there is a need to perform the memory size adjustment of the object memory area, and predicting the timing at which there is a need to perform the memory size adjustment of the object memory area, using the predictive model.

In some embodiments, a method for managing performance of database, the method comprising: selecting an object memory area predicted to be required to adjust a memory size after the current timing, using performance-related information of database collected for a predetermined time period or more; predicting timing at which there is a need to perform the memory size adjustment of the object memory area, using a predictive model for predicting the timing at which there is a need to perform the memory size adjustment of the object memory area, and providing information on the predicted timing to a user.

In some embodiments, An apparatus for managing performance of database comprising: a managed object selection unit that selects an object memory area predicted to be required to adjust a memory size after the current timing, using performance-related information of database collected for a predetermined time period or more; a predictive model generation unit that generates a predictive model for predicting the timing at which there is a need to perform the memory size adjustment of the object memory area, and a timing prediction unit that predicts the timing at which there is a need to perform the memory size adjustment of the object memory area, using the predictive model.

### BRIEF DESCRIPTION OF THE DRAWINGS

The above and other aspects and features of the present invention will become more apparent by describing in detail exemplary embodiments thereof with reference to the attached drawings, in which:

FIG. 1 is a diagram of a system to which an apparatus for managing performance of database according to an embodiment of the present invention is applied;

FIG. 2 is a block diagram of the apparatus for managing performance of database according to an embodiment of the present invention;

FIG. 3 is a diagram illustrating an example of a managed object selection unit;

FIG. 4 is a diagram illustrating an example of a hardware configuration of an apparatus for managing performance of database according to an embodiment of the present invention;

FIG. 5 is a diagram illustrating a flowchart of a method for managing performance of database according to another embodiment of the present invention;

FIG. 6 is a diagram illustrating a specific example of step S200;

FIG. 7 is a diagram illustrating a more specific example of step S210;

FIG. 8 is a diagram illustrating a more specific example of step S220;

FIG. 9 is a diagram illustrating a more specific example of step S230;

FIG. 10 is a flowchart illustrating an example in which a computing device generates a predictive model;

FIGS. 11 to 13 are diagrams illustrating information used to generate the predictive model; and

FIG. 14 is a diagram illustrating an example in which information provided to a user may different, depending on the remaining degree of the predicted timing.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

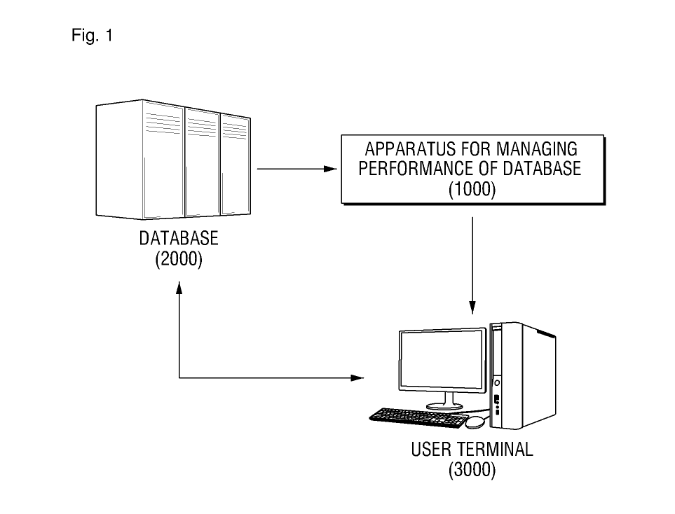

FIG. 1 is a diagram of a system to which apparatus for managing performance of database according to an embodiment of the present invention is applied.

Referring to FIG. 1, an apparatus 1000 for managing performance of database receives performance-related information of a database 2000 from the database 2000.

The performance-related information of the database 2000 may use the information of the storage about the performance information of the database 2000, like an automatic workload repository (AWR). For example, various data relating to performance of database 2000 may be stored in the AWR in the form of a snapshot.

The apparatus 1000 for managing performance of database may directly collect the performance-related information from the database 2000 and may acquire the information stored in the AWR.

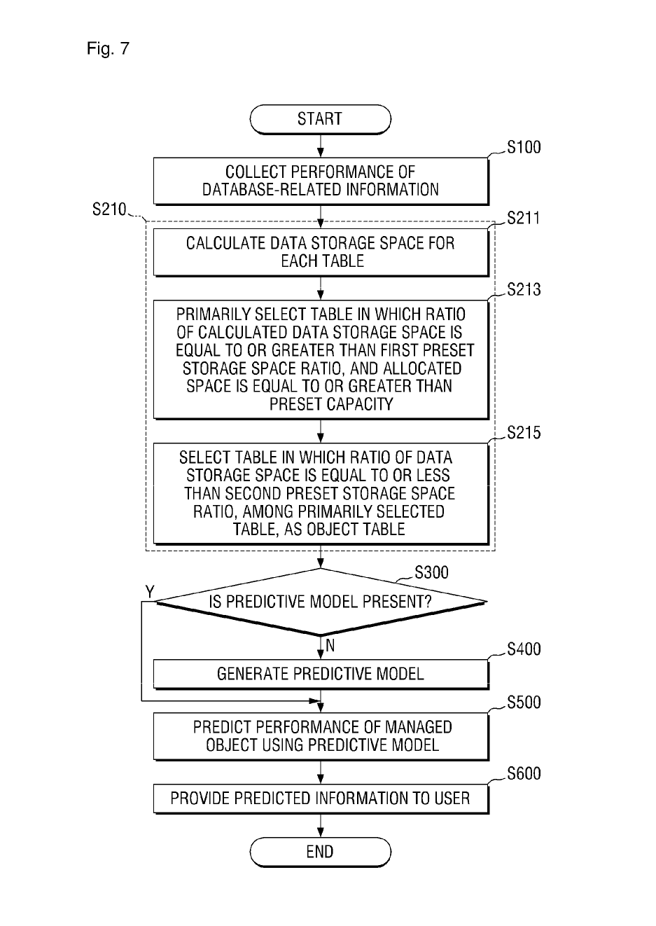

Specifically, for example, the performance-related information of the database 2000 may include an object allocation space for each table, a usage space, an average response rate of data files for each table space, and information on a memory hit ratio. The example of information included in the performance-related information of the database 2000 may be more fully understood with reference to FIGS. 7 to 12.

The apparatus 1000 for managing performance of database may collect the performance-related information of the database 2000 in units of minute and hour or may collect the performance-related information in units for each day.

The apparatus 1000 for managing performance of database predicts problems and timing of a degradation of the database 2000 which may occur in the future time, using the performance-related information of the collected database 2000.

The apparatus 1000 for managing performance of database may predict the problems and timing of the degradation of the database 2000 which may occur in the future time, using the performance-related information of the database 2000 collected for a predetermined time period. The performance-related information of the database 2000 collected for a predetermined time period means the information on performance of database 2000 for a predetermined time period or more, rather than meaning the collected time period.

As an amount of data used for prediction is large and the collected time period is long, the accuracy of the prediction of the apparatus 1000 for managing performance of database may be improved. To maintain a constant level of accuracy, the performance-related information of the database 2000 should be collected for at least a predetermined time period or more. The predetermined time period, for example, may be about 2 weeks.

The apparatus 1000 for managing performance of database may provide a user with the problems and timing of degradation of the database 2000, which may occur in the future.

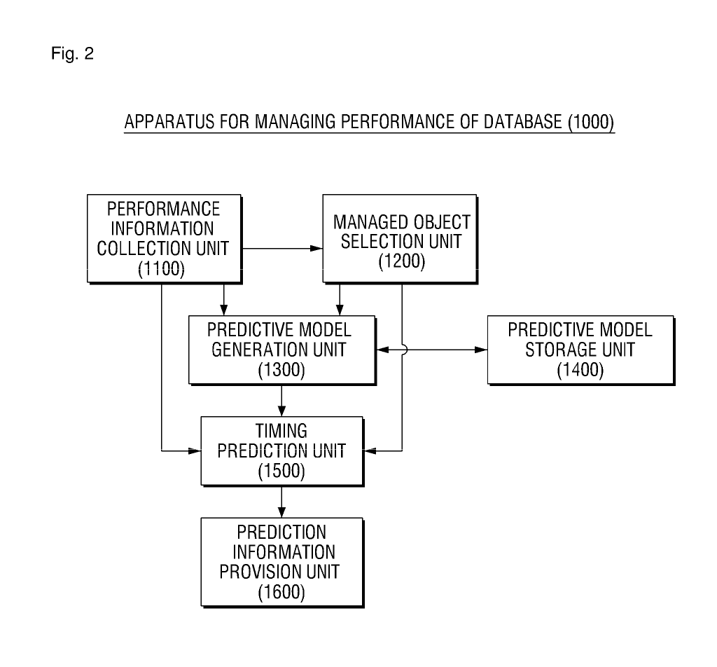

The apparatus 1000 for managing performance of database will be described in more detailed with reference to FIG. 2.

FIG. 2 is a block diagram of the apparatus 1000 for managing performance of database according to an embodiment of the present invention.

Referring to FIG. 2, the apparatus 1000 for managing performance of database according to an embodiment of the present invention may include a performance information collection unit 1100, a managed object selection unit 1200, a predictive model generation unit 1300, a predictive model storage unit 1400, a timing prediction unit 1500 and a prediction information provision unit 1600.

The performance information collection unit 1100 may collect the performance-related information from the database 2000. Alternatively, the performance information collection unit 1100 may obtain the performance-related information from the AWR which collects the performance-related information of the database 2000.

The managed object selection unit 1200 may select the managed object in which the performance tries to be specifically predicted. When predicting the performance of all objects such as all tables of the database 2000, since the time consumption is great and the efficiency is lowered, there is a need for a process of selecting a managed object.

The managed object selection unit 1200 of the apparatus 1000 for managing performance of database according to an embodiment of the present invention may select the object, which requires the tasks such as the table reorganization, the disc relocation and/or the adjustment of the memory size within a predetermined time period after the current timing, as the managed object.

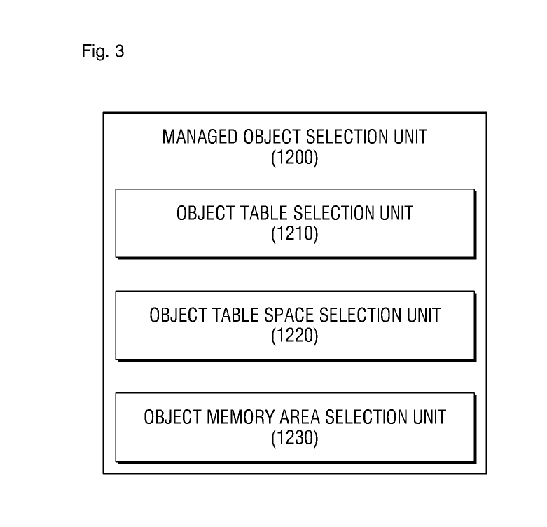

FIG. 3 is a diagram illustrating an example of the managed object selection unit 1200.

Referring to FIG. 3, the managed object selection unit 1200 may include at least one of an object table selection unit 1210, an object table space selection unit 1220 and an object memory area selection unit 1230.

The apparatus 1000 for managing performance of database may predict the timing that requires the table reorganization (Reorg), the disc relocation and/or the adjustment of the memory size. In such a case, the managed object selection unit 1200 may select the table requiring the table reorganization, the table space requiring the disc relocation and/or the memory area requiring the adjustment of the memory size, as the managed object.

The object table selection unit 1210 may select the object table predicted to be required to perform the table arrangement, as the managed object, using the performance-related information of the database 2000.

More specifically, the object table selection unit 1210 may select the table predicted to be required to perform the table reorganization at some point in the future, as a managed object, rather than the table required to currently immediately perform the table arrangement.

More specific contents of the object table selection will be described with reference to FIG. 7.

The object table space selection unit 1220 may select the table space predicted to be required to perform the disc relocation as a managed object, using the performance-related information of the database 2000.

More specifically, the object table selection unit 1210 may select the table space predicted to be required to perform the disc relocation at some point in the future, as a managed object, rather than the table required to currently immediately perform the disc relocation.

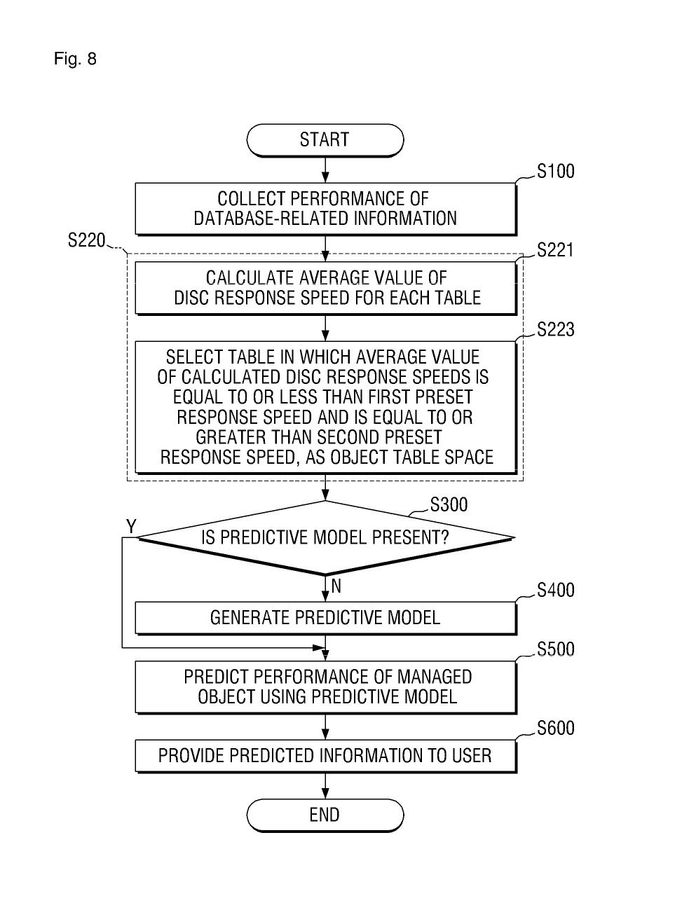

The table space will be described in more detail with reference to FIG. 8.

The object memory area selection unit 1230 may select the object memory area predicted to be required to perform the adjustment of the memory size, as a managed object, using the performance-related information of the database 2000.

Specifically, the object memory area selection unit 1230 may select the memory area predicted to be required to perform the adjustment of the memory size at some point in the future, as a managed object, rather than the memory area required to currently immediately perform the adjustment of the memory size.

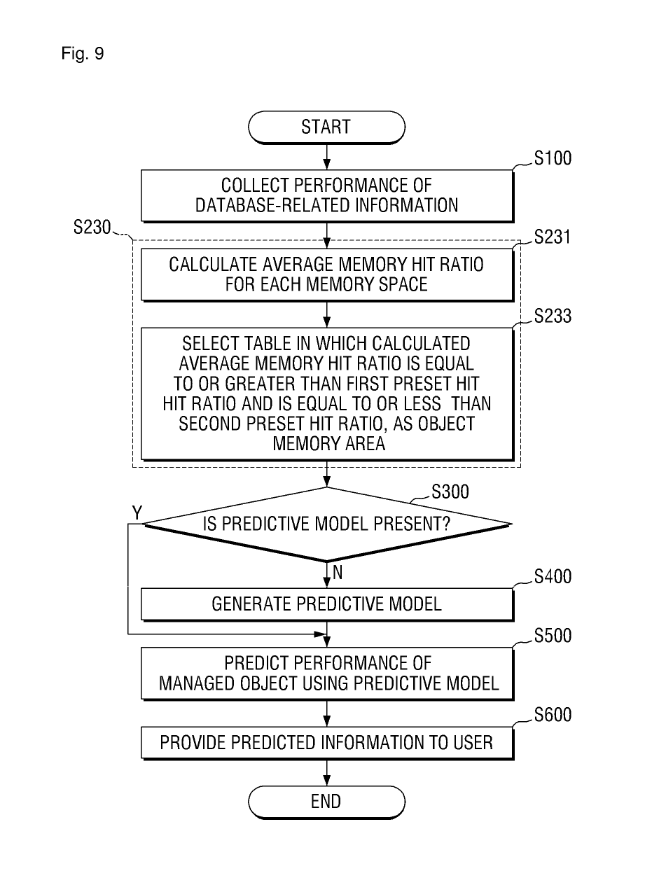

The object memory area selection unit 1230 will be described in more detail with reference to FIG. 9.

Referring to FIG. 2 again, the predictive model generation unit 1300 may generate a predictive model for predicting the timing at which it is required to perform a task for performance maintenance/improvement, such as the table reorganization (Reorg), the disc relocation and/or the adjustment of the memory size, using the performance information on the selected managed object among the performance information on the performance of database 2000 collected by the performance information collection unit 1100.

The predictive model generation unit 1300 may generate a predictive model using a linear regression analysis. Furthermore, the predictive model generation unit 1300 may also generate a predictive model, using a nonlinear regression analysis for improving an accuracy of the predictive model.

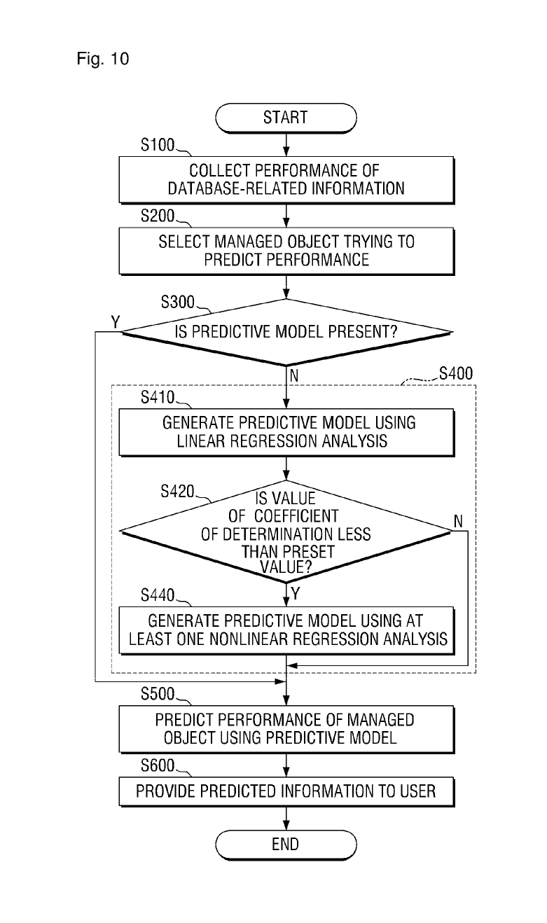

The generation of the predictive models will be described in more detail with reference to FIGS. 10 to 13.

The predictive model generation unit 1300 may predict the timing at which it is required to perform the task, using a preset predictive model or a predictive model generated earlier.

The preset predictive model or the predictive model generated earlier may be stored in the predictive model storage unit 1400.

Alternatively, the predictive model generation unit 1300 may generate a predictive model for predicting the specific task performing timing of the managed object each time the prediction is performed. Alternatively, the predictive model generation unit 1300 may periodically generate the predictive model for predicting the specific task performing timing of the managed object. Here, although the time period may be a time unit, it may be a unit of the number of times that performs the prediction.

The timing prediction unit 1500 may predict the type and timing of the tasks required for the managed object, for the performance maintenance/improvement of the database 2000, using the generated or stored predictive model.

More specifically, for example, the timing prediction unit 1500 may predict the timing at which the table arrangement of the object table is required. Alternatively, the timing prediction unit 1500 may predict the timing at which the disc relocation of the object table space is required. Alternatively, the timing prediction unit 1500 may predict the timing at which the adjustment of memory size of the object memory area is required.

The prediction information provision unit 1600 may provide information on the timing predicted by the timing prediction unit 1500 to a user.

For example, the prediction information provision unit 1600 may visually provide a user with information on the predicted timing through a display device. The display device may be a device included in a user terminal.

The user terminal 3000 may be provided as one of various components of an electronic device, such as a desktop computer, a workstation, a personal digital assistant (PDA), a portable computer, a wireless phone, a mobile phone, a smart phone, an e-book, a portable multimedia player (PMP), a portable game machine, a navigation device, a black box, a digital camera, a television, a device capable of transmitting and receiving information in a wireless environment, one of various electronic devices constituting a home network, one of various electronic devices constituting a computer network, one of various electronic devices constituting a telematics network, a smart card, or one of various components constituting a computing system.

The prediction information provision unit 1600 may visually provide information on the prediction timing and may report the presence of prediction information to a user through sound and/or vibration.

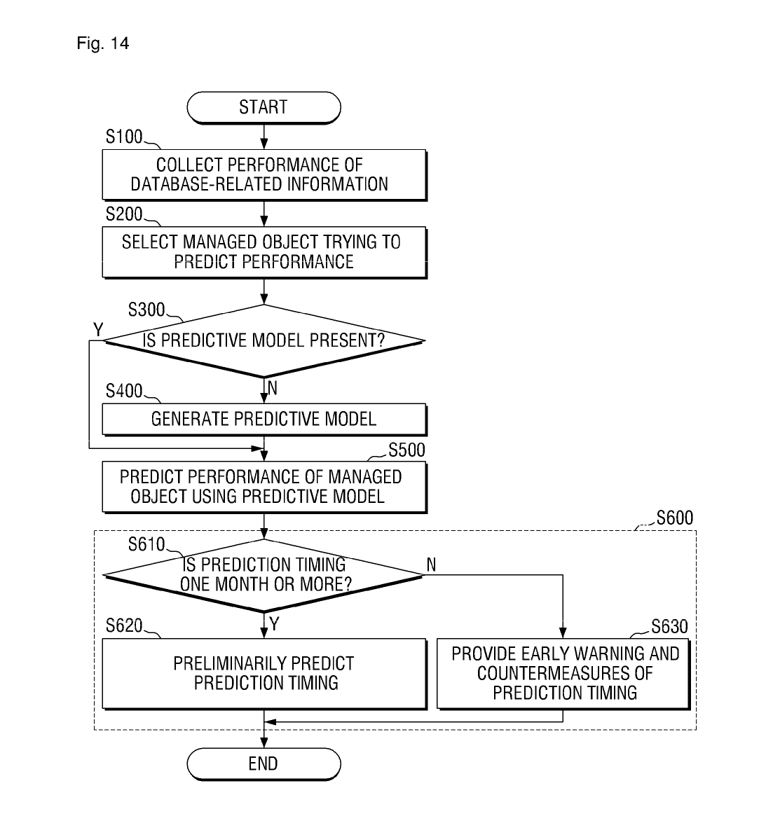

The provided information of the prediction information provision unit 1600 may vary depending on the degree in which the predicted timing remains. This will be described in more detail with reference to FIG. 14.

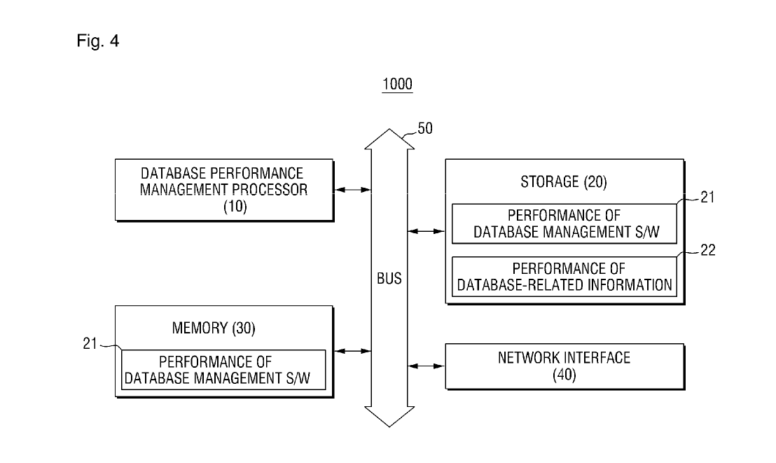

FIG. 4 is a diagram illustrating an example of a hardware configuration of the apparatus 1000 for managing performance of database according to an embodiment of the present invention.

The apparatus 1000 for managing performance of database according to the present embodiment may have a configuration of FIG. 4.

As illustrated in FIG. 4, the apparatus 1000 for managing performance of database may include a database performance management processor 10, a storage 20, a memory 30 and a network interface 40.

Further, the apparatus 1000 for managing performance of database may include a system bus 50 that is connected to the database performance management processor 10 and the memory 30 to serve as a data movement path.

Another computing device may be connected to the network interface 40. For example, another computing device connected to the network interface 40 may be a display device, a user terminal 3000 and the like.

The network interface 40 may be Ethernet, FireWire, a USB and the like.

The storage 20, but not limited to, may be achieved as a nonvolatile memory device such as a flash memory, a hard disc or the like.

The storage 20 stores data of a computer program 21 for management of database performance. Data of the computer program 21 for management of database performance may include a binary execution file and other resource files.

Further, the storage 20 may also store the performance-related information 21 of the collected database 2000.

The memory 30 loads the computer program 21 for management of database performance. The computer program 21 for management of database performance is provided to the database performance management processor 10 and is executed by the database performance management processor 10.

The database performance management processor 10 is a processor that is capable of executing the computer program 21 for management of database performance. However, the database performance management processor 10 may not be a processor that is capable of executing only the computer program 21 for management of database performance. For example, the database performance management processor 10 may also execute other programs, in addition to the computer program 21 for management of database performance.

The computer program 21 for management of database performance may include a series of operations that include a process of selecting an object table space predicted to be required to perform the disc relocation, using the performance-related information of the database 2000 collected for a predetermined time period or more, a process of predicting the timing at which it is required to perform the reorganization of the object table, using a preset predictive model to predict the timing at which it is required to perform the reorganization (Reorg) of the object table, and a process of providing a user with information on the prediction timing.

In addition, the computer program 21 for management of database performance may include a series of operations that include a process of selecting an object table space predicted to be required to perform the disc relocation, using the performance-related information of the database 2000 collected for a predetermined time period or more, a process of predicting the predictive model for predicting the timing at which it is required to perform the disc relocation of the object table space, and a process of predicting the timing at which it is required to perform the disc relocation of the object table space, using the predictive model.

Further, the computer program 21 for management of database performance may include a series of operations that include a process of selecting an object table space predicted to be required to adjust the memory size, using the performance-related information of the database 2000 collected for a predetermined time period or more, a process of predicting the predictive model for predicting the timing at which it is required to adjust the memory size of the object memory area, and a process of predicting the timing at which it is required to adjust the memory size of the object memory area, using the predictive model.

The storage 20 may not store information on the preset predictive model or the predictive model generated in the past. The computer program 21 for management of database performance may also perform a process of using the stored preset predictive model or the predictive model generated in the past, without the process of generating the predictive model.

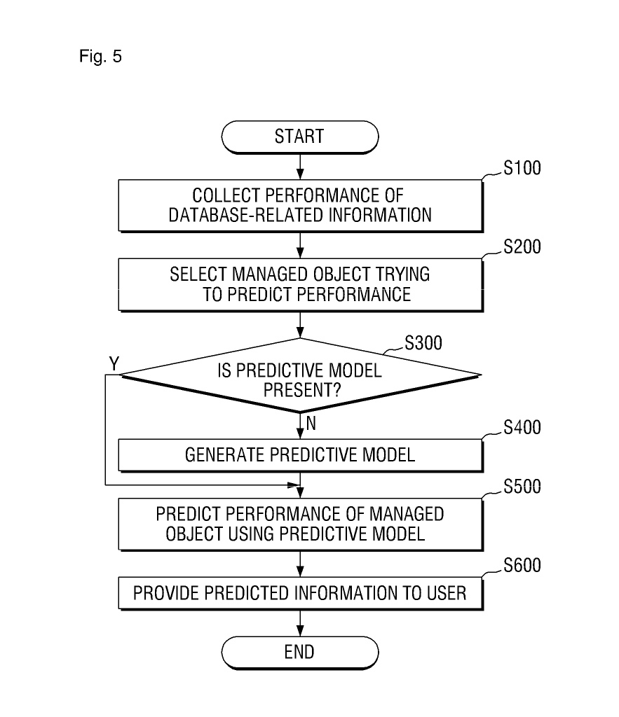

Hereinafter, a method for managing performance of database according to another embodiment of the present invention will be described with reference to FIGS. 5 to 14. This embodiment may be performed by a computing device having an arithmetic unit. The computing device, for example, may be the apparatus 1000 for managing performance of database according to an embodiment of the present invention. The configuration and operation of the apparatus 1000 for managing performance of database may be understood through the contents described with reference to FIGS. 1 and 4.

The contents of the method for managing performance of database described with reference to FIGS. 5 to 14 may also be applied to the apparatus 1000 for managing performance of database according to an embodiment of the present invention.

FIG. 5 is a diagram illustrating a flowchart of the method for managing performance of database according to another embodiment of the present invention.

Referring to FIG. 5, the computing device collects the performance-related information of the database 2000 (S100).

The computing device selects a managed object in which the performance is predicted (S200).

The computing device may generate a predictive model, when there is no predictive model (S300, S400).

The computing device may predict performance of the managed object, using the generated predictive model (S500).

The computing device may predict performance of the managed object, using the present predictive model, when there is a predictive model (S500).

The computing device may provide the predicted information to a user (S600).

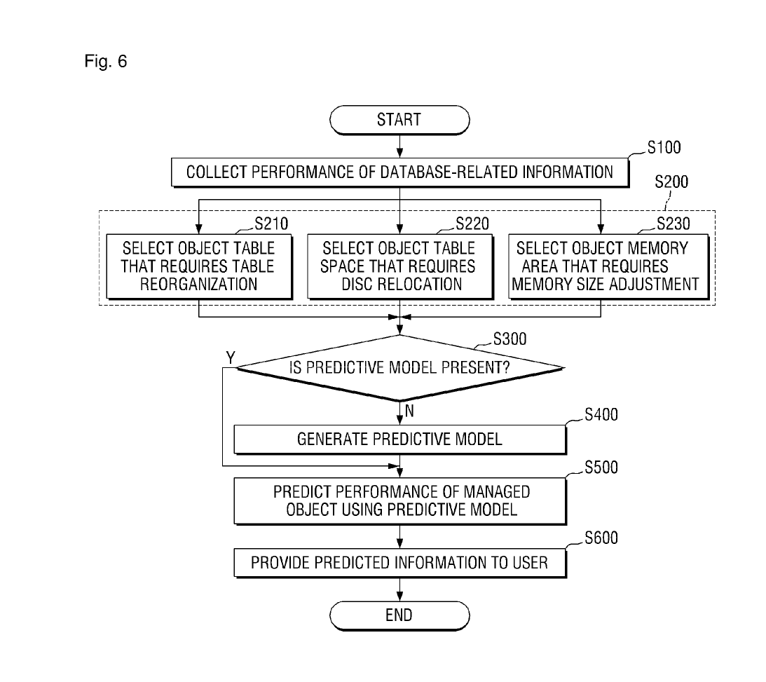

FIG. 6 is a diagram illustrating a specific example of step S200.

Referring to FIG. 6, the computing device may select the tables, which may require the table arrangement among the tables included in the database 2000, as a managed object (S210).

Step S210 will be described in more detail with reference to FIG. 7.

FIG. 7 is a diagram illustrating a more specific example of step S210.

An example of a method for selecting the object table as a managed object that requires the table arrangement will be described referring to FIG. 7.

The computing device calculates a ratio of a data storage space to an allocation space for each table included in the database 2000, using the performance-related information of the collected database 2000 (S211).

For example, the ratio of the data storage space may be calculated using the following Formula 1.

Ratio of data storage space=(num_row×avg_row_len)/(blocks×block_size)×100 [Formula 1]

The ratio of the data storage space means a ratio of an area actually occupied by the data in the area currently occupied by the table, with the exception of an empty space.

More specifically, for example, the ratio of the data storage space may be calculated as in Formula 1. In Formula. 1, 1 num_row refers to the number of records in the table. The avg_row_len refers to an average length of records in the table. The Blocks refer to the number of blocks, and the block_size refers to the size of the blocks. The size of the blocks may vary depending on the setting of the database.

The computing device primarily selects a table in which the ratio of the calculated data storage space is equal to or greater than a first preset storage space ratio, and the allocated space occupies the preset capacity or more, among the tables included in the database 2000 (S213).

The computing device may select a table, in which the ratio of the data storage space is equal to or less than a second preset storage space ratio, among the primarily selected table, as the object table (S215).

The second preset storage space ratio is greater than the first preset storage space ratio.

The preset capacity is regarded as a transaction table having a lot of data manipulation language (DML) tasks, and may be specified as the reorganization object table. For example, the preset capacity may be about 100 MB. In addition, the first preset data storage ratio may be set, on the basis of the timing at which the multi block I/O becomes larger than single block I/O of Index Lookup at the time of full table scan (FTS).

For example, the first data storage ratio may be set to about 50%. The second data storage ratio may be set, for example, about 80%.

When the data storage ratio is less than 50%, it may be set to a case where there is a need to immediately perform the table arrangement at this timing.

In such a case, the computing device may provide a user with a fact that there is a need to immediately perform the table arrangement of the object table, without having to predict the timing at which the task is required. That is, the table having the data storage ratio of less than 50% is not included in the object table that is necessary to predict the timing at which the table reorganization is required.

The computing device may not include a table, in which the ratio of the calculated data storage space exceeds the second preset data storage ratio, in the managed object, by regarding that it is not required to perform the table reorganization within certain time period.

Referring to FIG. 6 again, the computing device may select the table spaces, which may require the disc relocation, among the table spaces included in the database 2000, as a managed object (S220).

FIG. 8 is a diagram illustrating a more specific example of step S220.

An example of a method of selecting the object table space as a managed object requiring the disc relocation will be described referring to FIG. 8.

The computing device may calculate an average value of the disc response speeds for each table space, using the information on the disc response speeds for each data file allocated to each table space (S221). The average value of the disc response speeds means an average time at which the data is read from a physical disc.

For example, the computing device may calculate an average value of the disc response speeds using the following Formula 2.

Average value of disc response speeds=avg (read time total/physical read number) [Formula 2]

The average value of the disc response speeds means an average time taken to read the data from the disc, due to the fact that the data requested by the user does not exist in the memory.

The average value of the disc response speeds may be calculated using Formula 2.

The physical read number in Formula 2 means the number of blocks of the database that is read from the disc into the memory. The read time total means the total of the times taken to read the data from the disk.

The computing device may select the table space, in which the average value of the calculated disc response speeds is equal to or less than a first preset response speed and is equal to or greater than a second preset response speed, among the table spaces included in the database 2000, as the managed object (S223).

The second preset response speed is a value smaller than first preset response speed. That is, the response corresponding to the second preset response speed is faster than the response corresponding to the first preset response speed. For example, the first preset response speed may be about 20 ms. The second preset response speed may be about 10 ms.

The computing device considers the immediate disc relocation at the current timing rather than the future timing, when the average value of the disc response speeds exceeds the first preset response speed, and may provide the information to a user.

That is, in the computing device, a case where the average value of the disc response speeds exceeds the first preset response speed is a case where there is no need to apply the timing prediction using the predictive model.

The computing device considers that the table space, in which the average value of the calculated disc response speeds is less than the second preset response speed, does not require the disc relocation within certain time period, and may not include the table space in the managed object.

Referring to FIG. 6 again, the computing device may select the object memory area predicted to be required to adjust the memory size (S230).

FIG. 9 is a diagram illustrating a more specific example of step S230.

An example of a method for selecting the memory area as the managed object requiring the adjustment of the memory size will be described referring to FIG. 9.

The computing device may calculate an average memory hit ratio for each memory space, using the performance-related information of the collected database 2000 (S231).

For example, the computing device may calculate the memory hit ratio using Formula 3.

The average memory hit ratio=avg (average hit ratio for each snap_id of each metric_name) [Formula 3]

The first used data and the executed SQL are temporarily stored in the memory, and at this time, the average memory hit ratio means a ratio in which the data and the SQL requested to be used by the user are already present in the memory.

The average memory hit ratio may be calculated using Formula 3. Metric means an amount of change, metric_name in Formula 3 means the name of amount of change, and for example, Buffer Cache Hit (%), Library Cache Hit (%) and the like are present. The snap_id means the identification information ID of snapshots that are periodically stored. For example, ID may be denoted by consecutive digits by a time period of an hour unit.

The computing device may select the memory space, in which the calculated average memory hit ratio is a second preset hit ratio or less, while being the first preset set hit ratio or more, as the memory space that is the managed object (S233).

The second preset hit ratio has a value greater than the first preset hit ratio.

The first preset hit ratio may be set to about 90%, and the second preset hit ratio may be set to about 95%.

The computing device considers that there is a need to immediately adjust the memory size at the current timing rather than the future timing, when the calculated average memory hit ratio is equal to or less than the first preset hit ratio, and may report it to a user.

The computing device considers that the memory area, in which the calculated average memory hit ratio is equal to or greater than the second preset hit ratio, does not require the memory resize adjustment within a predetermined time period of the future, and may not include the memory area in the managed object.

A first preset storage space ratio, a second preset storage space ratio, a preset capacity, a first preset response speed, a second preset response speed, a first preset hit ratio and/or a second preset hit ratio may change, depending on the user's request, the maintenance request performance of the database 2000, the highest performance of the database 2000, the average performance of the database 2000 and the like.

The database 2000 may include information that is necessary to calculate the ratio of the data storage space, the average value of the disc response speed and the average memory hit ratio, using Formulas 1 to 3. The necessary information may include the information corresponding to each item of Formulas 1 to 3 or the information that is necessary to derive the information corresponding to each item.

Referring to FIG. 5 again, the computing device predicts performance of the managed object, using the present predictive model, when a predictive model for predicting the timing requiring the task in the managed object is present (S300, S500).

The computing device may generate a predictive model to apply a predictive model that is more appropriate for the current situation, even when the predictive model is present or absent (S400).

FIG. 10 is a flowchart illustrating an example in which the computing device generates a predictive model.

Referring to FIG. 10, the computing device may generate a predictive model using linear regression analysis (S410).

The computing device predicts the performance of the managed object, using the generated predictive model, when the value of the coefficient of determination of the predictive model generated using the linear regression analysis is equal to or greater than the preset value (S420, S500). That is, the computing device may predict the timing at which the task needs to be performed to maintain performance of the managed object, using the predictive model generated by the linear regression analysis.

The computing device may generate a predictive model using at least one nonlinear regression analysis, when the value of the coefficient of determination of the predictive models generated using the linear regression analysis is less than the preset value (S420, S440).

The preset value may be about 90. As the preset value is high, the accuracy and reliability of the prediction timing may be improved.

Performance of the managed object may predicted, using the predictive model having the highest value of the coefficient of determination among the predictive models generated by at least one nonlinear regression analysis (S500).

Alternatively, it is also possible to perform a process of directly using the predictive model, when the value of the coefficient of determination of the predictive model generated using one nonlinear regression analysis exceeds the preset value, and generating the predictive model using another nonlinear regression analysis, when not exceeding the preset value.

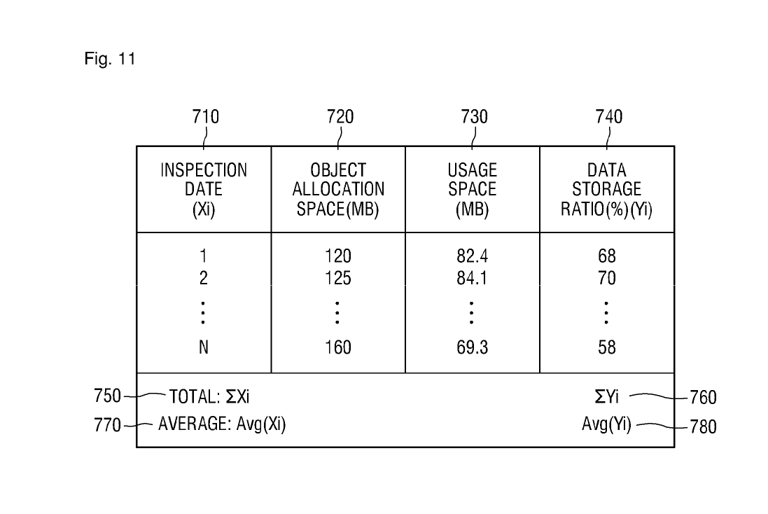

The method of generating the predictive model by the computing device will be described referring to FIGS. 11 13 and Formulas 4 to 13.

Ŷ=b0+b1*X [Formula 4]

Ŷ in Formula 4 is a predictive model using the linear regression analysis.

b0 is a constant and means Y−b1*X. b1 is also a constant and means Σ[(Xi−X)*(Yi−Y)]/Σ[(Xi−X)²].

The value of the coefficient of determination may be calculated using Formula 5 below.

R²={(1/N)*Σ[(Xi−X)*(Yi−Y)]/(σ_{X}*σ_{Y})}² [Formula 5]

R₂ in Formula 5 is a value of the coefficient of determination, and X and Y means the average. For example, X is a value corresponding to Avg (Xi) in FIGS. 11 to 13, and Y is may be a value corresponding to the Avg (Yi). σ_{X} and σ_{Y} means a standard deviation.

FIGS. 11 to 13 are diagrams illustrating information used to generate the predictive models.

Referring to FIG. 11, FIG. 11 illustrates the information used for generating the predictive model, when the managed object is a table and the execution task is a table reorganization.

The computing device may generate a predictive model, using information on the ratio of the table to the data storage space and the linear regression analysis described referring to Formulas 4 and 5 to make predictions about the timing at which the table reorganization of the object table is performed.

An inspection date may be date that checks performance of database 2000 or a date that takes snapshot. 1 through N means the sequence of time, may be several time units and may also be several day units.

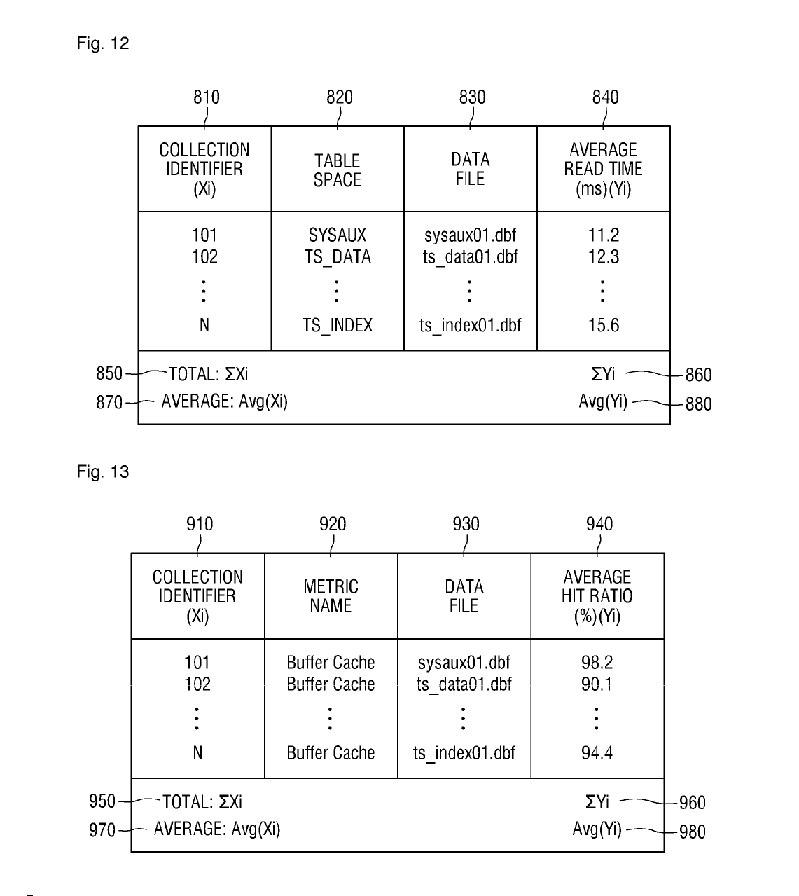

FIG. 12 illustrates the information used for generating the predictive model, when the managed object is a tables pace, and the execution task is a disc relocation.

The computing device may generate a predictive model, using information on the average value of response speeds for each disc of the object table space and the linear regression analysis described referring to Formulas 4 and 5 to make predictions about the timing at which the disc relocation of the object table space is performed.

A collection identifier may be a date that checks performance of database 2000 or a date that takes snapshot. 101 through N of each collection identifier may mean the sequence of time, may be several time units and may also be several day units.

FIG. 13 illustrates the information used for generating the predictive model, when the managed object is a memory area, and the execution task is a memory size adjustment.

The computing device may generate a predictive model, using information on the average memory hit ratio and the linear regression analysis described referring to Formulas 4 and 5 to make predictions about the timing at which the memory size adjustment of the object memory space is performed.

The collection identifier is as described in FIG. 12.

The performance-related information of the database 2000 collected by the computing device may include information on an object allocation space 720, a usage space 730, a table space name 820, a data file name 830, a metric name 920, a data file name 930 and the like.

The computing device may calculate and obtain information on the data storage ratio 740, the average Read time 840 and the average predictive value 940, using the information included in the performance-related information of the collected database 2000, and Formulas 1 to 3.

In FIGS. 11 to 13, Xi (710, 810, 910), Yi (740, 840, 940), σXi (750, 850, 950), σYi (760, 860, 960), Avg (Xi) (770, 870, 970) and Avg (Yi) (780, 880, 980) is understood to be used in Formulas 4 and 5.

The method for generating a predictive model using the nonlinear regression analysis will be described with reference to Formulas 6 to 9. However, the method for generating a predictive model using the nonlinear regression analysis is not limited to the description using Formulas 6 to 9, and it is also possible to use another nonlinear regression analysis.

ln Ŷ=b0+b1*X [Formula 6]

In Formula 6, b0 means a constant as in Formula 7. b1 means a constant as in Formula 8.

b1=Σ[(Xi−X)*(lnYi−lnY)]/Σ[(Xi−X)²] [Formula 7]

b0=lnY−b1*X [Formula 8]

Reliability and accuracy of the predictive model may be calculated using the value of the coefficient of determination according to Formula 9 below.

R²={(1/N)*Σ[(Xi−X)*(lnYi−lnY)]/(σₓ*σln_{Y})}² [Formula 9]

In Formula 9, R² is a value of the coefficient of determination. In Formulas 6 to 9, X and means an average. For example, X is a value corresponding to Avg (Xi) in FIGS. 11 to 13, and Y may be a value corresponding to Avg (Yi). σₓ and σ_{lnY} means a standard deviation.

The computing device may also use anther nonlinear regression analysis, other than the nonlinear regression analysis using Formula 6 to 9 utilized to use a predictive model.

For example, the computing device may also generate a predictive model, further using at least any one of Quadratic Model using Formula 10, Reciprocal Model using Formula 11, Logarithmic Model using Formula 12, and Power Model using Formula 13.

Ŷ=(b0+b1*X)² [Formula 10]

Ŷ=1/(b0+b1*X) [Formula 11]

Ŷ=b0+b1*log (X) [Formula 12]

Ŷ=10^{(b0+b1*log (X))} [Formula 13]

FIG. 13 suggests that the computing device preferentially uses the linear regression analysis to generate a predictive model, but it is not limited thereto, and it is also possible to generate a predictive model in parallel, using the linear regression analysis and the nonlinear regression analysis, and to use the predictive model having the greatest value of the coefficient of determination.

The computing device predicts the timing at which the task to be performed is necessary, using the predictive model.

Specifically, when using the predictive model generated using the linear regression analysis as the predictive model, the computing device calculates the timing at which the Ŷ value of the predictive model becomes a preset predicted reference value.

For example, in the case of the table arrangement task, the predicted reference value may be set to 0.5. This is a value that is set on the basis of the ratio 50% of the data storage space.

Further, in the case of the disc relocation task, the predicted reference value may be set to 20. This is a value that is set on the basis of the average value 20 ms of the disc response speed.

Further, in the case of the memory size adjustment task, the predicted reference value may be set to 0.9. This is a value that is set on the basis of the memory hit ratio of 90%.

The predicted reference value may be changed, depending on the user's requirements, the optimal performance of the database 2000, the maintenance performance level of the database 2000 and the like.

The computing device may calculate the timing requiring the table reorganization task by calculating the timing at which the value Ŷ becomes 0.5. Further, the computing device may calculate the timing requiring the disc relocation task by calculating the timing at which the value Ŷ become 20. Further, the computing device may calculate the timing requiring the table reorganization task by calculating the timing at which the value Ŷ become 0.9. The constant values (b0, b1) constituting each Ŷ have different types of information depending on the performed tasks (see FIGS. 11 to 13).

The computing device may provide information on the calculated timing to the user, when the prediction timing is calculated. The user may recognize that it is necessary to perform the task prior to the timing by receiving the provision of information on the timing.

FIG. 14 is a diagram illustrating an example in which the information provided to the user may be different, depending on the extent that the prediction timing remains.

Referring to FIG. 14, the computing device may make the information provided to the user different, depending on the extent that the prediction timing remains.

The computing device may provide the information to the user to the extent that it reports only simple information, when a lot of prediction timing remains. Meanwhile, the computing device may enhance the warning level or may provide the information on the specific countermeasures to the user, when the prediction timing is pending.

For example, the computing device provides the information on the predicted timing to a user, when the prediction timing is one month or more (S610, S620). When the prediction timing is less than one month, the computing device provides it as early warning of the information on the prediction timing, and may provide detailed information on the task to be performed and countermeasures (S610, S630). The time of one month may be changed depending on the user's request, the type of task to be performed and the like.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method for managing performance of database, the method comprising:
selecting an object table predicted to be required to perform a table reorganization (Reorg) after the current timing, using performance-related information of database collected for a predetermined time period or more;
generating a predictive model for predicting the timing at which there is a need to perform the reorganization (Reorg) of the object table, and
predicting the timing at which there is a need to perform the reorganization of the object table, using the predictive model.

2. The method of claim 1, further comprising:
providing information on the predictedn timing to a user.

3. The method of claim 1, wherein the selection of the object table comprises:
calculating a ratio of a data storage space to an allocation space ratio for each table included in the database, using the performance-related information of the collected database;
primarily selecting a table in which the ratio of the calculated data storage space is equal to or greater than a first preset storage space ratio, and the allocated space occupies the preset capacity or more, among the tables included in the database; and
selecting a table, in which the ratio of the data storage space is equal to or less than a second preset storage space ratio among the primarily selected table, as the object table

4. The method of claim 3, wherein the generation of the predictive model comprises:
generating the predictive model, using information on the ratio of the data storage space of the object table, and a linear regression analysis.

5. The method of claim 4, wherein the prediction of the timing comprises:
predicting the timing at which there is a need to perform the reorganization of the object table, only when the value of the coefficient of determination of the linear regression analysis is equal to or greater a preset value.

6. The method of claim 5, wherein when the value of the coefficient of determination of the linear regression analysis is less than the preset value,
the generation of the predictive model comprises:
generating the predictive model, using the information on the ratio of the data storage space of the object table and at least one nonlinear regression analysis.

7. The method of claim 1, wherein the prediction of the timing comprises:
calculating the timing corresponding to a preset table reorganization necessary criteria, using the predictive model; and
predicting the calculated timing as timing at which there is no need to perform the reorganization of object table.

8. A method for managing performance of database, the method comprising:
selecting an object table space predicted to be required to perform a disc relocation after the current timing, using performance-related information of database collected for a predetermined time period or more;
generating a predictive model for predicting the timing at which there is a need to perform the disc relocation of the object table space, and
predicting the timing at which there is a need to perform the disc relocation of the object table space, using the predictive model.

9. The method of claim 8, wherein the performance-related information of the collected database includes information on disc response speeds for each data file allocated to each table space, and
the selection of the object table space comprises:
calculating an average value of the disc response speeds for each table space, using the information on the disc response speeds for each data file; and
selecting a table space, in which the average value of the calculated disc response speeds is equal to or less than a first preset response speed and is equal to or greater than a second preset response speed, among the table spaces included in the database, as the managed object.

10. The method of claim 9, wherein the generation of the predictive model comprises:
generating the predictive model, using the calculated disc response speed and a linear regression analysis.

11. A method for managing performance of database, the method comprising:
selecting an object memory area predicted to be required to adjust a memory size after the current timing, using performance-related information of database collected for a predetermined time period or more;
generating a predictive model for predicting the timing at which there is a need to perform the memory size adjustment of the object memory area, and
predicting the timing at which there is a need to perform the memory size adjustment of the object memory area, using the predictive model.

12. The method of claim 11, wherein the selection of the object memory area comprises:
calculating an average memory hit ratio for each memory space, using the performance-related information of the collected database; and
selecting a memory space, in which the calculated average memory hit ratio is equal to or greater than a first preset hit ratio and is equal to or less than a second preset hit ratio, as the object memory space.

13. The method of claim 12, wherein the generation of the predictive model comprises:
generating the predictive model, using the calculated average memory hit ratio and linear regression analysis.
